(19) United States
(12) Patent Application Publication
(10) Pub. No.: US 2008/0150881 A1
(43) Pub. Date: Jun. 26, 2008

(54) Flat panel display and driving method thereof

(75) Inventors: Shou Lung Chen, Shatin (HK); Chen-Jung Tsai, Hsinchu (TW); Kwan Wah Ng, Kowloon Bay (HK); Huajun Peng, Tai Po (HK)

Correspondence Address: MERCHANT & GOULD PC, P.O. BOX 2903, MINNEAPOLIS, MN, 55402-0903, US

(73) Assignee: Hong Kong Applied Science and Technology Research Institute Co. Ltd., Shatin (HK)

(21) Appl. No.: 11/904,165

(22) Filed: Sep. 26, 2007

(30) Foreign Application Priority Data
Dec. 22, 2006 (CN) 200610170011.X

(51) Int. Cl. G09G 3/36

(52) U.S. Cl. 345/102

(57) ABSTRACT

The present invention provides a flat panel display, which is characterized by comprising a display panel; a backlight assembly having a plurality of light-emitting sources arranged in a predetermined pattern; and a driving circuit coupled to the display panel and the backlight assembly. The driving circuit could be operative to receive a first signal and determine a second signal according to the first signal and the predetermined pattern of the plurality of light-emitting sources; to use the second signal to control the light emission of the plurality of light-emitting sources; to determine a third signal according to the light-emitting results of the light-emitting sources controlled by the second signal, and drive the display panel by the third signal. The backlight assembly and flat panel display disclosed in the present invention could achieve the effects of improving quality, power saving, high dynamic contrast, and high color depth.

### BACKGROUND OF THE INVENTION

1. Field of the Invention

The present invention relates to a backlight assembly applied in a flat panel display. More particularly, the present invention relates to a flat panel display having the backlight assembly and a method of driving the same.

2. Description of the Prior Art

An interface, such as a display, plays a core role between a user and the environment in which enormous information are dealt with at high speed. Particularly, a flat panel display, which is slender, power saving, radiationless as well as compatible to manufacturing process of semiconductor, gradually occupies an important position in connecting a user and the aforementioned environment. A flat panel display could be applied to diverse fields, such as consumer electronic products, personal mobile electronic products, medical instruments, and exploitation facilities, etc.

Generally, the recognition of the brightness for a human being falls within a range varying in five grades or so (the unit for each grade here is a logarithm of a candela per square meter, i.e., log cd/m²). The brightness of common displays mostly varies in a range of two to three grades, which means that it is still possible to improve the quality of the displays to an extent.

An solution so-called dynamic backlighting display method was devised to improve the image quality and contrast up to three grades. The method drives the backlight to create a desired color or brightness distribution based on the input video signal. Cooperatively, the LCD control signal is modified in response to the distribution of backlight. Because the backlighting can be dimmed to reduce the light leakage from light crystal valve, the contrast is increased.

For the purpose of aforementioned dynamic backlighting display approach to enhance the quality and contrast of an image displayed in a flat panel display having a backlight assembly, the light-emitting intensity of the backlight assembly is enhanced (e.g., an increase of the number of light-emitting diodes). Consequently, the above design increases the amount of pixels as well as enhances the brightness and improves the image quality. However, the increase of number of LEDs induces additional cost of the backlight assembly, and more electricity is consumed to drive the backlight assembly. Further, high power consumption accompanies additional heat dissipation devices for dissipating the heat, e.g., fans, for sinking the overall temperature of the flat panel display, which incurs more expenditure.

In view of the above, flat panel displays on the market lack sufficient pixel resolution, dynamic contrast and color depth, but they consume high power. Therefore, a flat panel display with high image quality, high dynamic contrast, high color depth as well as low power consumption is desired on the market.

### SUMMARY OF THE INVENTION

In order to overcome the defects of the flat panel display in the prior art concerning insufficient pixel resolution, high power consumption, and insufficient dynamic contrast and color depth, the present invention provides a flat panel display with high dynamic range and a method of driving the same, which can improve the image quality, save power, and has high dynamic contrast and high color depth.

A backlight assembly provided by an embodiment of the present invention comprises a plurality of light-emitting sources arranged in a predetermined pattern; and a driving circuit coupled to the plurality of light-emitting sources for receiving a first signal, a second signal is determined according to the first signal and the predetermined arrangement pattern of the plurality of light-emitting sources, and the second signal is employed to control the light emission of the plurality of light-emitting sources.

A flat panel display provided by another embodiment of the present invention comprises a display panel; a backlight assembly which comprises a plurality of light-emitting sources arranged in a predetermined pattern; and a driving circuit coupled to the display panel and the backlight assembly. The driving circuit could be operative to receive a first signal and determine a second signal according to the first signal and the predetermined arrangement pattern of the plurality of light-emitting sources; to use the second signal to control the light emission of the plurality of light-emitting sources; to determine a third signal according to light-emitting results of the light-emitting sources controlled by the second signal, and to drive the display panel with the third signal.

Another embodiment of the present invention provides a method of driving a flat panel display, wherein the flat panel display comprises a display panel and a backlight assembly comprising a plurality of light-emitting sources arranged in a predetermined pattern. The method comprises: receiving a first signal and determining a second signal according to the first signal and the predetermined arrangement pattern of the plurality of light-emitting sources; using the second signal to control the light emission of the plurality of light-emitting sources; determining a third signal according to light-emitting results of the light-emitting sources controlled by the second signal, and driving the display panel with the third signal.

The flat panel display provided by the present invention has the advantages as follows. The backlight assembly provides more equivalent pixels without additional light-emitting sources, and whereby the flat panel display of the present invention is three times the pixel resolution of a conventional display. Thus, the image quality is improved and the cost of the backlight assembly is reduced. As compared to the conventional display, the flat panel display of the present invention could save 30%-50% power consumption, and whereby the temperature is reduced during the operation of the display. Consequently, no more heat dissipation device such as a fan or a heat sink is required. Moreover, the dynamic contrast is enhanced (>10,000:1), and the color depth is increased.

Other objectives and achievements of the present invention could be realized with reference to the following description of the present invention and claims as well as the accompanied drawings.

### BRIEF DESCRIPTION OF THE DRAWING

FIG. 1A shows an arrangement of light-emitting sources in a backlight assembly according to an exemplary embodiment of the present invention;

FIG. 1B shows an arrangement of light-emitting sources in a backlight assembly according to another exemplary embodiment of the present invention;

FIG. 1C shows an arrangement of light-emitting sources in a backlight assembly according to still another exemplary embodiment of the present invention;

FIG. 2A shows an arrangement of light-emitting sources in a backlight assembly according to an exemplary embodiment of the present invention;

FIG. 2B shows pixels of the light-emitting sources of the backlight assembly achieved by the arrangement of FIG. 2A according to the present invention;

FIG. 2C shows the control of the light emission of a plurality of the light-emitting sources of the backlight assembly in the arrangement of FIG. 2A in different time segments of a predetermined period according to an exemplary embodiment of the present invention;

FIG. 3 is a schematic diagram of a flat panel display adopting the backlight assembly of the present invention; and

FIG. 4 is a flow chart that illustrates a method of driving the flat panel display of FIG. 3.

### DETAILED DESCRIPTION

The following embodiments of the present invention would be employed to illustrate the technical scheme of the present invention.

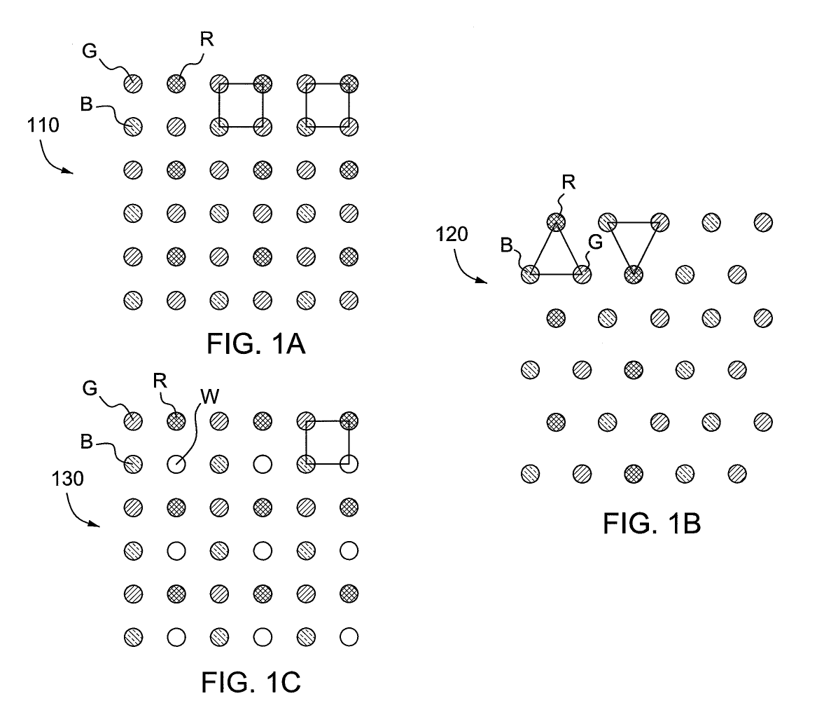

In an embodiment, a backlight assembly of the present invention includes a plurality of light-emitting sources arranged in a predetermined pattern. As shown in FIG. 1A, the backlight assembly 110 has a plurality of light-emitting sources, which could be LEDs of different colors, e.g., red light diodes (R), green light diodes (G), and blue light diodes (B). In this embodiment, R, G, B light-emitting sources of three different colors could be arranged in a square array.

FIG. 1B shows an arrangement of the light-emitting sources in a backlight assembly 120 according to another exemplary embodiment of the present invention. The backlight assembly 120 has a plurality of light-emitting sources, which could be LEDs of different colors, e.g., red light diodes (R), green light diodes (G), and blue light diodes (B). In this embodiment, R, G, B light-emitting sources of three different colors could be arranged in a triangular array.

Referring to FIG. 1C, which shows an arrangement of the light-emitting sources in a backlight assembly 130 according to another exemplary embodiment of the present invention. The backlight assembly 130 has a plurality of light-emitting sources, which could be LEDs of different colors, e.g., white light diodes (W), red light diodes (R), green light diodes (G), and blue light diodes (B). In this embodiment, W, R, G, B light-emitting sources of four different colors could be arranged in a square array.

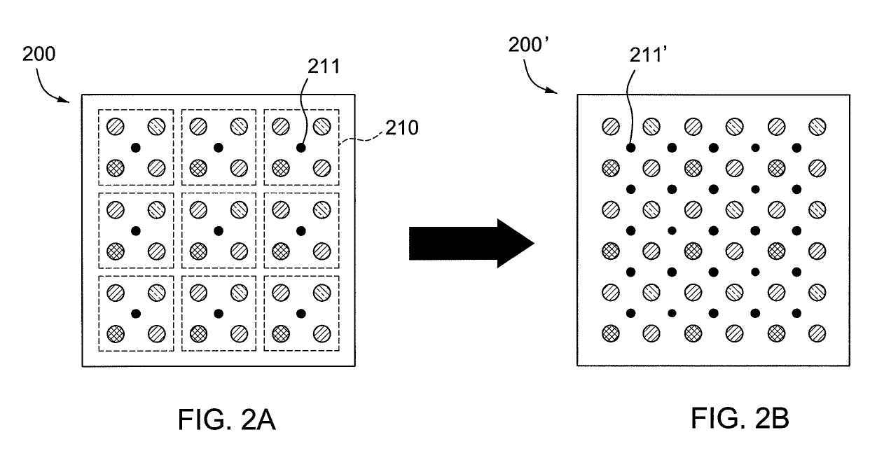

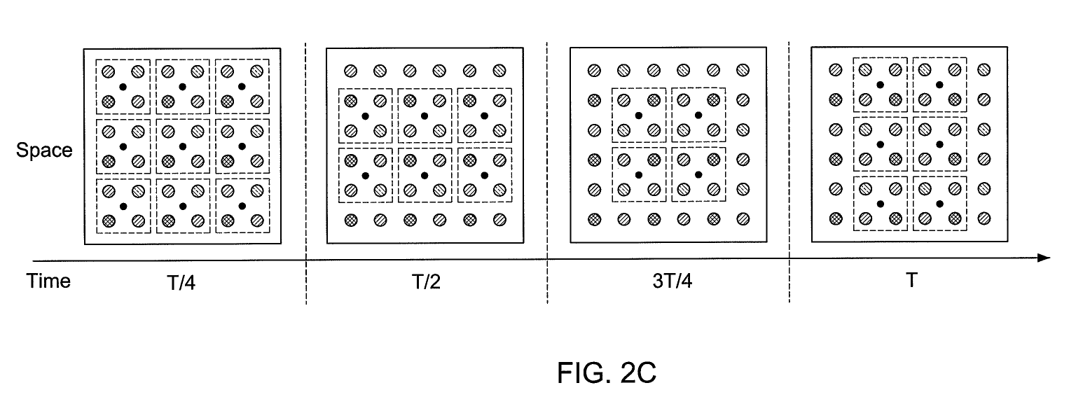

Referring to FIG. 2A, the arrangement of the light-emitting sources of a backlight assembly 200 is the same as that of the backlight assembly 110 of FIG. 1A. In this embodiment, only nine physical unit regions 210 appear in the backlight assembly 200 of FIG. 2A for the convenience of explanation. The physical unit region 210 could be composed of four light-emitting sources, and in this embodiment, could be composed of, but not limited to, two green light-emitting sources, one red light-emitting source, and one blue light-emitting source. Each physical unit region 210 has a white unit center 211, i.e. pixel position. According to the backlight assembly 200 as shown in FIG. 2A, nine pixels could be employed to display images. However, under the teaching of the method of the present invention, the number of the display pixels are lifted up to twenty-five, such as the backlight assembly 200′ as shown in FIG. 2B. In FIG. 2B, the fact that the physical unit region 210′ has twenty-five white unit centers 211′ (the pixels for displaying images) could be deduced from a geometric position. In other words, there are twenty-five available pixels.

Referring to FIG. 2C, which is a schematic diagram that illustrates how to control different light-emitting sources to obtain more available pixels (twenty-five in this embodiment) in the given physical unit regions (nine in this embodiment) according to the backlight assembly as shown in FIG. 2A. In this embodiment, a predetermined period T could be divided into, but not limited to, four time segments for the convenience of explanation. The predetermined period T could also be divided into two, three, five time segments, but the divided time segments must not be greater than the minimum time of persistence of vision of human. As shown in FIG. 2C, in the first time segment T/4, the light emission of all light-emitting sources is controlled by an input specific signal, whereby nine available pixels are obtained in nine physical unit regions. In the second time segment T/2, only the light-emitting sources in the physical unit regions enclosed by dash lines emit light under the control of the input specific signal, whereby six available pixels are obtained. In the third time segment 3T/4, only the light-emitting sources in the physical unit regions enclosed by dash lines emit light under the control of the input specific signal, whereby four available pixels are obtained. In the fourth time segment T, only the light-emitting sources in the physical unit regions enclosed by dash lines emit light under the control of the input specific signal, whereby six available pixels are obtained. In this embodiment, twenty-five available pixels could be obtained under the above control method during a predetermined period based on the backlight assembly in which the light-emitting sources are arranged in the predetermined pattern, and whereby the effect of image quality improvement, power saving, high dynamic contrast and high color depth could be achieved.

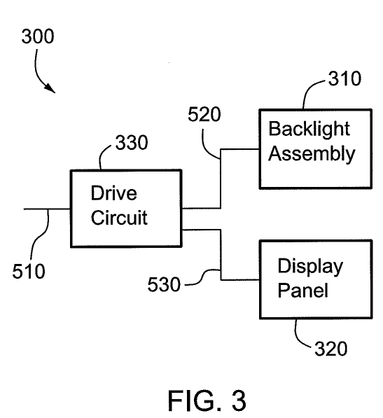

In FIG. 3, a flat panel display 300 is an exemplary embodiment of the present invention. The flat panel display 300 mainly includes a backlight assembly 310, a display panel 320 (such as a liquid crystal display panel), and a driving circuit 330. In this embodiment, the light-emitting sources of the backlight assembly 310 could be arranged in, but not limited to, the patterns of FIG. 1A, 1B, or 1C. In this embodiment, the driving circuit 330 is electrically connected to the display panel 320 and the backlight assembly 310 respectively, and receives an input signal 510 (such as a video signal or an image signal). The driving circuit 330 determines a light-emitting source control signal 520 according to the input signal 510 and the arrangement of a plurality of light-emitting sources of the backlight assembly 310, and controls the light emission of the plurality of light-emitting sources by the light-emitting source control signal 520. The driving circuit 330 also determines a display panel control signal 530 according to the light-emitting results of the light-emitting sources controlled by the light-emitting source control signal 520 so as to drive the display panel 320.

As shown in FIG. 3, in another embodiment of the present invention, the light-emitting source control signal 520 could include N light-emitting source control sub-signals (not shown), where N is a natural number greater than 1 (for example, N is 4 in FIG. 2C). The N light-emitting source control sub-signals are obtained by dividing the input signal 510 according to different regions of the predetermined arrangement pattern of the plurality of light-emitting sources. In this embodiment, the light-emitting source control sub-signals are determined based on the average value, peak value, or mean grayscale value of the input signal (e.g., the image signal), which could be a digital signal of 2-8 or higher bits for controlling the brightness of the light emitted by the light-emitting sources. The driving circuit 330 sequentially, respectively controls the plurality of light-emitting sources (for example, to control the light output intensity) by N light-emitting source control sub-signals. The display panel control signal 530 includes N display panel control sub-signals calculated respectively according to the light-emitting results of the light-emitting sources controlled by the N light-emitting source control sub-signals, for sequentially driving the display panel 320.

In another embodiment of the present invention, the driving circuit 330 sequentially, respectively controls the plurality of light-emitting sources by N light-emitting source control sub-signals. The display panel control signal 530 includes N display panel control sub-signals calculated according to the light-emitting results of the light-emitting sources controlled by the N light-emitting source control sub-signals. However, in this embodiment, the N display panel control sub-signals are weighted and then used to drive the display panel 320.

In another embodiment of the present invention, the driving circuit 330 uses a signal obtained by weighting the N light-emitting source control sub-signals to control the plurality of light-emitting sources. The display panel control signal 530 is calculated according to the light-emitting results of the light-emitting sources controlled by the signal obtained by weighting the N light-emitting source control sub-signals, so as to drive the display panel 320.

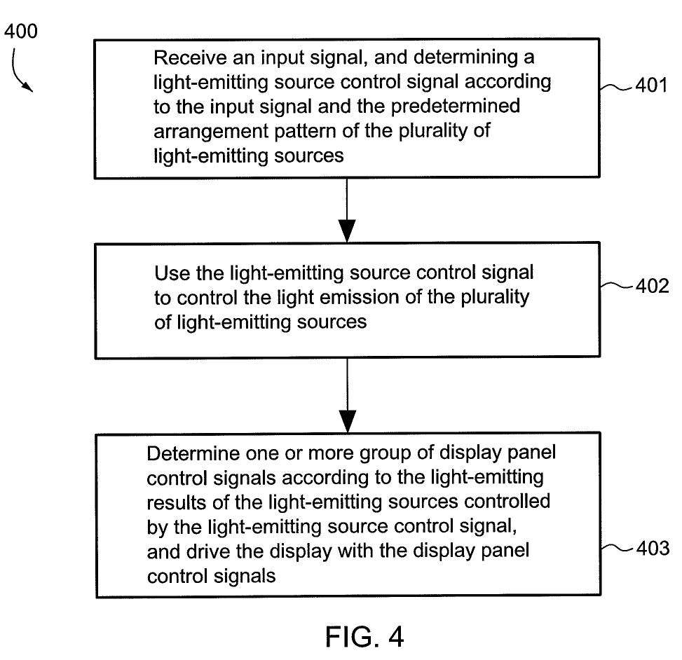

A driving method as shown in FIG. 4 is an exemplary embodiment of the present invention, which can drive the flat panel display 300 as shown in FIG. 3 by the following steps:

Step 401: receiving an input signal, and determining a light-emitting source control signal according to the input signal and the predetermined arrangement pattern of the plurality of light-emitting sources;

Step 402: using the light-emitting source control signal to control the light emission of the plurality of light-emitting sources; and

Step 403: determining one or more group of display panel control signals according to the light-emitting results of the light-emitting sources controlled by the light-emitting source control signal, and driving the display panel with the display panel control signals.

In light of the above, the backlight assembly or flat panel display provided by the present invention has the advantages as follows. Firstly, the backlight assembly provides more equivalent pixels (three times the pixel resolution of a conventional display) without additional light-emitting sources (such as light-emitting diodes), and thus the image quality is improved and the cost of the backlight assembly is reduced. Secondly, as compared to the conventional display, the flat panel display of the present invention could cut down 30%-50% power consumption, and whereby the temperature is reduced during the operation of the display. Consequently, no more heat dissipation device such as a fan or a heat sink is required. Moreover, the dynamic contrast is enhanced (>10,000:1), and the color depth is increased.

The technical content and features of the present invention are described above, however, those skilled in the art can make various modifications and variations without departing from the teaching and disclosure of the present invention. In view of the foregoing, the scope of the present invention is not limited to the disclosed embodiments, but covers other modifications and variations of the present invention that fall within the scope of the following claims.

1. A method of driving a flat panel display comprising a display panel and a backlight assembly having a plurality of light-emitting sources arranged in a predetermined pattern, the method comprising:
receiving a first signal, and determining a second signal according to the first signal and the predetermined arrangement pattern of the plurality of light-emitting sources;
using the second signal to control the light emission of the plurality of light-emitting sources; and
determining a third signal according to light-emitting results of the light-emitting sources controlled by the second signal, and driving the display panel with the third signal.

2. The method as claimed in claim 1, wherein the display panel is a liquid crystal display panel.

3. The method as claimed in claim 1,
wherein the plurality of light-emitting sources comprise light-emitting diodes (LEDs) of different colors or white light LEDs.

4. The method as claimed in claim 1, wherein the first signal is a video signal.

5. The method as claimed in claim 1, wherein the second signal comprises N first sub-signals, where N is a natural number greater than 1, and the N first sub-signals are obtained by dividing the first signal according to different regions of the predetermined arrangement pattern of the plurality of light-emitting sources.

6. The method as claimed in claim 5, wherein the N first sub-signals are further employed to sequentially control the light emission of the plurality of light-emitting sources respectively.

7. The method as claimed in claim 6, wherein the third signal comprises N second sub-signals calculated according to the N first sub-signals.

8. The method as claimed in claim 7, wherein the N second sub-signals are further employed to sequentially drive the display panel respectively.

9. The method as claimed in claim 7, wherein a signal obtained by weighting the N second sub-signals is further employed to drive the display panel.

10. The method as claimed in claim 5, wherein a signal obtained by weighting the N first sub-signals is employed to control the light emission of the plurality of light-emitting sources.

11. The method as claimed in claim 10, wherein the third signal is determined according to the light-emitting results of the plurality of light-emitting sources controlled by the signal obtained by weighting the N first sub-signals.

12. A flat panel display, comprising:
a display panel;
a backlight assembly comprising a plurality of light-emitting sources arranged in a predetermined pattern; and
a driving circuit coupled to the display panel and the backlight assembly,
wherein:
said driving circuit being operative to receive a first signal, and determine a second signal according to the first signal and the predetermined arrangement pattern of the plurality of light-emitting sources;
use the second signal to control the light emission of the plurality of light-emitting sources; and
determine a third signal according to a light-emitting result of the light-emitting sources controlled by the second signal, and drive the display panel with the third signal.

13. The flat panel display as claimed in claim 12, wherein the display panel is a liquid crystal display panel.

14. The flat panel display as claimed in claim 12, wherein the plurality of light-emitting sources comprise LEDs of different colors or white light LEDs.

15. The flat panel display as claimed in claim 12, wherein the first signal is a video signal.

16. The flat panel display as claimed in claim 12, wherein the second signal comprises N first sub-signals, where N is a natural number greater than 1, and the N first sub-signals are obtained by dividing the first signal according to different regions of the predetermined arrangement pattern of the plurality of light-emitting sources.

17. The flat panel display as claimed in claim 16, wherein the N first sub-signals are further employed to sequentially control the light emission of the plurality of light-emitting sources respectively.

18. The flat panel display as claimed in claim 17, wherein the third signal comprises N second sub-signals calculated according to the N first sub-signals.

19. The flat panel display as claimed in claim 18, wherein the N second sub-signals are further employed to sequentially drive the display panel respectively.

20. The flat panel display as claimed in claim 16, wherein a signal obtained by weighting the N first sub-signals is employed to control the light emission of the plurality of light-emitting sources.

21. The flat panel display as claimed in claim 18, wherein a signal obtained by weighting the N second sub-signals is further employed to drive the display panel.

22. The flat panel display as claimed in claim 20, wherein the third signal is determined according to the light-emitting results of the plurality of light-emitting sources controlled by the signal obtained by weighting the N first sub-signals.

23. A backlight assembly comprising:
a plurality of light-emitting sources arranged in a predetermined pattern; and
a driving circuit coupled to the plurality of light-emitting sources for receiving a first signal, determining a second signal according to the first signal and the predetermined arrangement pattern of the plurality of light-emitting sources, and using the second signal to control the light emission of the plurality of light-emitting sources.

24. The backlight assembly as claimed in claim 23, wherein the plurality of light-emitting sources comprise LEDs of different colors.

25. The backlight assembly as claimed in claim 23, wherein the first signal is a video signal.

26. The backlight assembly as claimed in claim 23, wherein the second signal comprises N first sub-signals, where N is a natural number greater than 1, and the N first sub-signals are obtained by dividing the first signal according to different regions of the predetermined arrangement pattern of the plurality of light-emitting sources.

27. The backlight assembly as claimed in claim 26, wherein the N first sub-signals are further employed to sequentially control the light emission of the plurality of light-emitting sources respectively.

28. The backlight assembly as claimed in claim 26, wherein a signal obtained by weighting the N first sub-signals is employed to control the light emission of the plurality of light-emitting sources.
